(19) United States
(12) Patent Application Publication
(10) Pub. No.: US 2010/0018740 A1
(43) Pub. Date: Jan. 28, 2010

(54) Method and apparatus for allowing future installation of wires, cables, fibers and the like within a structure

(76) Inventor: Mike L. Massey, Midland, TX (US)

Correspondence Address: LAW OFFICES OF CHRISTOPHER L. MAKAY, 1634 Milam Building, 115 East Travis Street, San Antonio, TX, 78205, US

(21) Appl. No.: 12/220,366

(22) Filed: Jul. 24, 2008

(51) Int. Cl. H02G 3/04; E04B 1/00

(52) U.S. Cl. 174/68.1; 52/741.1

(57) ABSTRACT

A method and apparatus for adding wires, cables, fibers or the like from an accessible part of a structure, such as an attic or crawlspace to an interior room from within the walls of the structure, by installing an attachment section, tubing and penetration sleeves during the construction of the structure. The tubing is made from a compressible insulated material to prevent heated or cooled air from escaping prior to or after the installation of wires, cables, fibers or the like. The attachment section is secured to an interior support in the accessible area with the tubing attached to the attachment section. The tubing is compressed to prevent heated or cooled air loss through the tubing. The tubing extends to an access point, typically behind an interior wall. Structural supports such as plates and subfloors are penetrated using hollow rigid sleeves which when mated with the tubing, creates a continuous hollow passageway for the wires, cables, fibers or the like. The attachment section contains a surface for identifying the termination point of the tubing, which can be written on or have a label affixed.

### BACKGROUND OF THE INVENTION

1. Field of the Invention

The present invention relates to a method and apparatus for allowing the future installation of wires, cables, fibers or the like, within a structure.

2. Description of the Related Art

During the construction phase of commercial and residential structures, in addition to basic electrical wiring, builders must install wires, cables, fiber and other suitable means for sending data or signals, such as cable television, satellite television, telephone, internet or video surveillance feeds throughout the building.

As technology changes and upgrades to existing technology occur, there is often a need to install additional wire, cable, fiber and the like. In the construction of many buildings, provisions are not made for the installation of additional wires, cables and fiber.

In those structures where builders do anticipate this need, limited methods exist to allow for this installation. In the rare situations where this is done, usually flexible round conduit is installed from a convenience outlet box located within the walls of the structure to run to an accessible area, such as in a crawl space or an attic. This is a cumbersome and costly process, and doing so in this manner allows heat loss at the point of wall penetration due to the inability to insulate the empty conduit.

If there are no provisions made for the installation of wires, cables or fibers, it is a difficult, expensive, labor-intensive and sometimes dangerous job to later add these to a completed structure. An installer must locate the exact area inside the attic or crawl space to drill a penetration hole into the wall cavity where the installer wishes to run the new wire, cable or fiber. Searching for this exact area is time-consuming and may expose the installer to such hazards as dirty insulation, dust, rodent droppings, insects, and other contaminants. These may be harmful to the installer, and if the installer tracks these throughout the structure, may be harmful to the inhabitants of the building as well.

In addition, many attics or crawl spaces have insulation to minimize the radiation and convection transfer of heat from the habitable part of the structure. Common insulation methods used are fiberglass blankets (BATT) which are laid down, or blown-in insulation which is dispersed using compressed air. Best results are achieved when the insulation is uniformly dispersed and remains in place. When additional wire, cables or fibers are installed, often insulation must be moved to access the desired wall cavity from above. If the insulation is not replaced properly, the effectiveness of the insulation is reduced, increasing energy use.

Finally, the installation additional wire, cables or fibers can be dangerous to both the installer and the structure. Installers must be careful not to step on non-load bearing sections of an attic or crawl space to avoid falling through to a lower floor, which can cause personal injury or death in addition to property damage. Installers must also avoid drilling penetration holes in the wrong locations, which can damage walls and ceilings. Drilling blindly into a wall or ceiling can also damage existing hidden pipes or wiring, which can result in injury and costly repairs.

Accordingly, a preinstalled system containing a flexible insulated hollow tubing with an accessible sealable opening located in an attic or crawl space that passes from area of a structure to another that would allow for the future installation of wires, cables, fibers or the like would be significantly advantageous.

### SUMMARY OF THE INVENTION

In accordance with the present invention, a method and apparatus for allowing the future installation or addition of wire, cables, fiber and the like from an attic, crawl space or other accessible area into the wall cavities of a room of a structure.

In the preferred embodiment, the tubing would be generally round and cylindrical in shape when uncompressed and made from a flexible, compressible material with insulating properties, such as compressible foam. The interior of the tube would be hollow.

The system would be installed during the construction of the structure, generally during the rough-in phase prior to the installation of the drywall. A tube compression means capable of securing and compressing the tubing would be situated in a convenient location within an attic or crawlspace. The tube compression means could be a clamp, clip or other device capable of applying pressure to the compressible tubing, thereby closing off the end and preventing heated or cooled air loss through the tube.

The tube compression means in another embodiment would also have a labeling surface for identifying the location within the structure where the tube would terminate and the wires, cables, fiber and the like would be accessible. The labeling surface in one embodiment might be an attached material, such as paper or cardboard, capable of being written on and connected to the tube compression means by any suitable attachment means, such as wire, plastic band, adhesive or the like. In the preferred embodiment, the tube compression means would be disposed within a housing which integrates the tube compression means, the labeling surface and a mounting means for attaching the housing to a structural support, to form a tube securing member.

In the preferred embodiment, the tube securing member would be mounted in the attic or crawlspace, preferably on an interior support structure such as a gable stud. The tubing would run from the tube securing member to the wall cavity behind the desired area where the tubing would terminate.

Between the tube securing member and the termination point of the tubing, the tubing would travel through open areas as well as have to penetrate beams, joists and other structural supports. When traveling through open areas, the tubing could be secured to structural supports using flexible material capable of securing the tubing to the structural supports, such as bands or straps, which could be secured to the structural supports using a securing means, such as nails or staples.

To penetrate into a wall cavity through a structural support, such as a wood plate, a penetration hole would be drilled through the plate. A rigid sleeve sized to fit snugly within the penetration hole would be inserted into the penetration hole. The tubing extending from the attachment device would be cut to a length sufficient to reach the rigid sleeve, with the end stretched to fit over the rigid sleeve section protruding from the penetration hole. Another section of tubing would be stretched over the opposing section of the rigid sleeve and would continue to the desired location.

Wire, cables, fiber and the like would be inserted into the hollow portion of the tubing either during the installation of the system or at a later date when needed. The hollow portion of the tube and any installed sleeves would allow the wires, cables, fiber and the like to be pushed through one end and have it emerge at the other.

Once wires, cables, fibers or the like are installed in the tubing, the tubing would be inserted into the tube securing member and the tubing compressed.

It is therefore an object of the present invention to provide an inexpensive conduit that can be installed into a structure to allow for the future installation of wires, cables and fibers into the structure.

It is a further object of the present invention to provide a preinstalled conduit that is insulated to prevent the loss of heated or cooled air from the structure.

It is a further object of the present invention to provide conduit that installs into a structural penetration hole without tools and without using any separate means to secure it, such as brackets or adhesive.

It is still a further object of the present invention to provide a conduit for the future installation of wires, cables, fibers and the like, that once installed, minimizes disruption to the existing insulation and allows for safer installation.

Still other objects, features, and advantages of the present invention will become evident to those of ordinary skill in the art in light of the following,

### BRIEF DESCRIPTIONS OF THE DRAWINGS

FIG. 1 is a perspective view of the uncompressed tubing prior to the addition of wires, cables fibers and the like.

FIG. 2 is a perspective view of the uncompressed tubing with a flat cable and wire installed.

FIG. 3 is a side partially elevated view of a tube compressing clip.

FIG. 4 is a side partially elevated view of a tube compressing clip with an attached label.

FIG. 5 is a side view of a tube compressing label with a slot clamp for tube compression.

FIG. 6 is a front perspective view of screw clamp for tube compression.

FIG. 7 is an exploded perspective view of the tube securing member and the tubing.

FIG. 8 is a front view of the tube securing member with the tubing in place and a flat cable and wire installed, prior to compression of the tubing.

FIG. 9 is a front view of the tube securing member with the tubing in place and a flat cable and wire installed, after the compression of the tubing.

FIG. 10 is a top view of a tube secured to a structural support using a securing strap.

FIG. 11 is an end view of a tube secured to a structural support using a securing strap.

FIG. 12 is a side view of the rigid sleeve.

FIG. 13 is an upper view of a wood plate with a penetration hole drilled therethrough.

FIG. 14 is a side view of a wood plate with a penetration hole and a rigid sleeve inserted into the penetration hole.

FIG. 15 is a side view of a wood plate with a penetration hole and a rigid sleeve inserted into the penetration hole, with the tubing attached to the rigid sleeve.

FIG. 16 is a side view of a first embodiment showing a one story structure, with a tube compression means attached to the tube assembly which extends from the tube compression means through a plate in the attic into a wall cavity.

FIG. 17 is a side view of a second embodiment showing a one story structure, with the tube securing member secured to a gable stud in the attic, and the tube assembly extending from the attachment device through a plate in the attic into a wall cavity.

FIG. 18 is a side view of a second embodiment showing a two story structure, with the tube securing member secured to a gable stud in the attic and the tube assembly extending from the attachment device through a plate in the attic into a second story wall cavity and continuing through into a first story wall cavity.

### DETAILED DESCRIPTION OF THE PREFERRED EMBODIMENTS

Although the disclosure hereof is detailed and exact to enable those skilled in the art to practice the invention, the physical embodiments herein disclosed merely exemplify the invention that may be embodied in other specific structure. While the preferred embodiment has been described, the details may be changed without departing from the invention, which is defined by the claims.

Like referenced characters are used throughout this description to identify like parts.

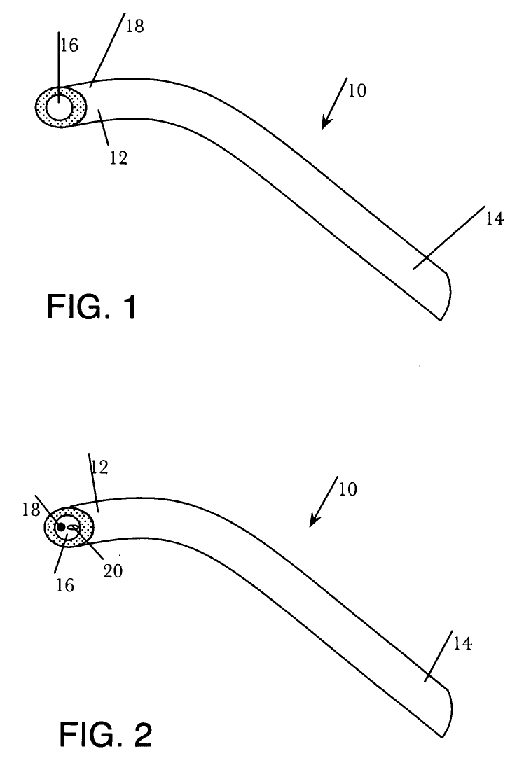

As referenced in FIGS. 1 and 2, a tubing 10, where a first end 12 and a second end 14, is shown. The tubing 10 is composed of a compressible insulating material. Disposed within the tubing 10 is a hollow interior 16 extending between the first end 12 and second end 14. In the preferred embodiment, the material is a compressible plastic foam, but can be any material capable of retaining a substantially cylindrical and circular shape when uncompressed and having insulative properties that minimizes the loss of heated and cooled air. The tubing 10 can be compressed to seal the hollow interior 16 from air leakage. In FIG. 1, the tubing 10 is shown in an uncompressed state, exposing hollow interior 16, though which wires, cables, fibers or the like may be inserted to travel from first end 12 to second end 14. In FIG. 2, a wire 18 and a flat cable 20 are shown disposed within the hollow interior 16, with the wire 18 and flat cable 20 emerging from first end 12 and second end 14.

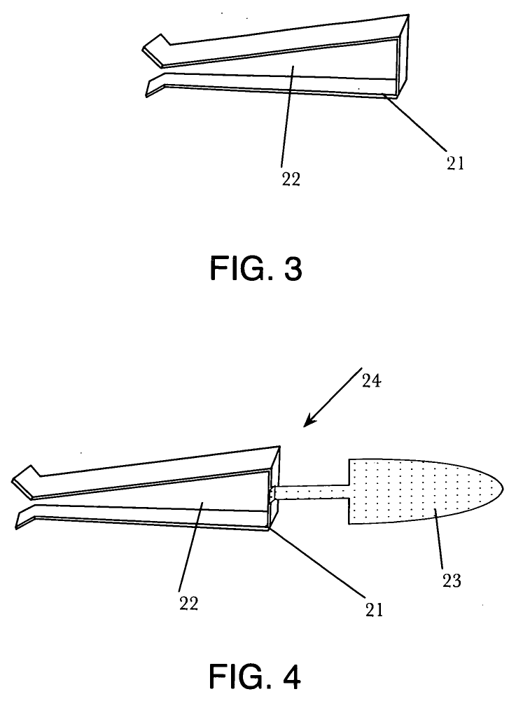

As referenced in FIGS. 3, 4, 5 and 6, various embodiments of a tube compression means and tube securing members are shown. In FIG. 3 a clip 21 is shown, whereby an opening 22 can receive the tubing 10 (not shown), applying pressure on the tubing 10 to compress and seal the tubing 10. In FIG. 4, the clip 21 is combined with a label 23, which is secured to the clip 21 by any suitable means such as wire, plastic strap, string or a band, compressing and securing the tubing 10, and identifying the termination location of the tubing 10. The label 23 and the clip 22 combine to form a tube securing member 24.

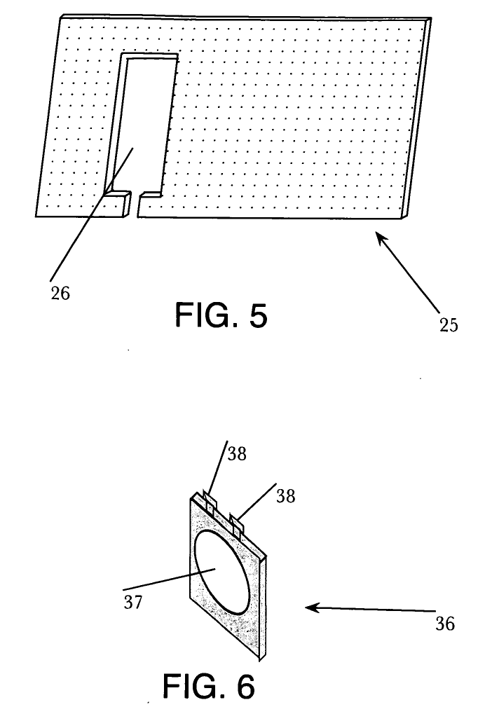

In FIG. 5, another embodiment of a tube securing member is shown. A tube securing member 25 is comprised of a rigid or semi-rigid label with a slot 27 for the insertion and clamping of the tubing 10 (not shown). The tube securing member 25 may be written on to indicate the termination point of the tubing 10.

In FIG. 6, a tube clamp 36 is shown, comprised of an opening 37 and screws 38. The tubing 10 (not shown) is inserted into opening 37. The screws 38 are turned to compress the tubing 10 within the opening 37, thereby sealing the tubing 10.

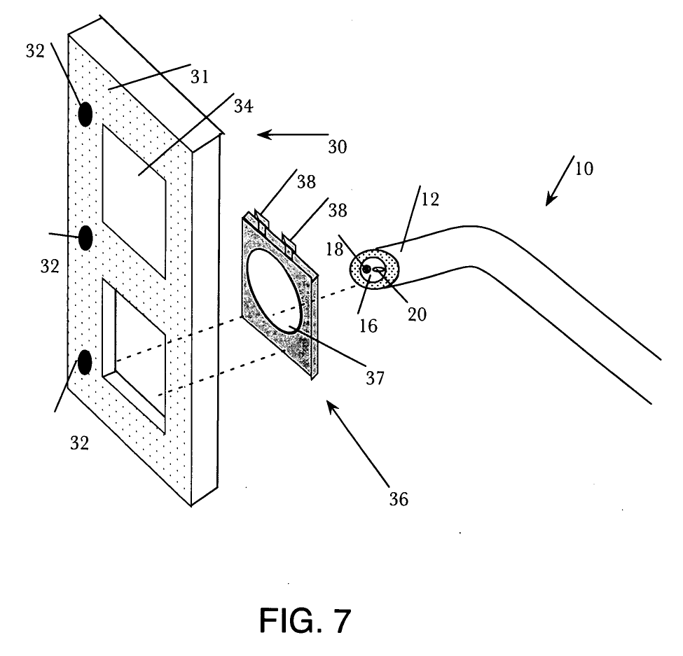

As referenced in FIG. 7 the preferred embodiment of a tube securing member is shown. The tube securing member 30 is comprised of a base section 31, a labeling section 34, and the tube clamp 36. Disposed within the base section 31 are three mounting holes 32. The tube securing member 30 is shown having three mounting holes 32 that can receive screws or nails for the purpose of securing the tube securing member 30 to an interior support within a structure. Although in the preferred embodiment shown, the tube securing member 30 uses three mounting holes 32 in combination with fasteners such as screws and nails, the number of mounting holes 32 can be greater or fewer depending on the mounting situation, and any suitable mounting means, including staples, adhesive, Velcro or the like may be used to secure the tube securing member 30. The tube securing member 30 contains the labeling surface 34 onto which the termination location of the tubing 10 may be indentified, either by affixing a label or writing directly on the labeling surface 34.

The base section 31 of the tube securing member 30 communicates with the tube clamp 36. In the preferred embodiment, the base section 31 would have an opening sized and shaped to receive the tube clamp 36 so that it secured to the base section 31 of tube securing member 30. The tube clamp 36 is sized and shaped to receive the tubing 10 to pass therethrough and secure the tubing 10 to the tube securing member 30. In the preferred embodiment shown in FIGS. 7, 8 and 9, after inserting the wire 18 and the flat cable 20 through the first end 12 of tubing 10 to exit at second end 14, the tube clamp 36 compresses the tubing 10 by turning the screws 38, which apply pressure onto the tubing 10, squeezing it into a compressed state. While the compression method shown in the preferred embodiment is the pressure on tubing 10 applied by screws 38, any method that can compress and uncompress the tubing 10 may be used, including releasable clips, snaps, clamps, bands or the like.

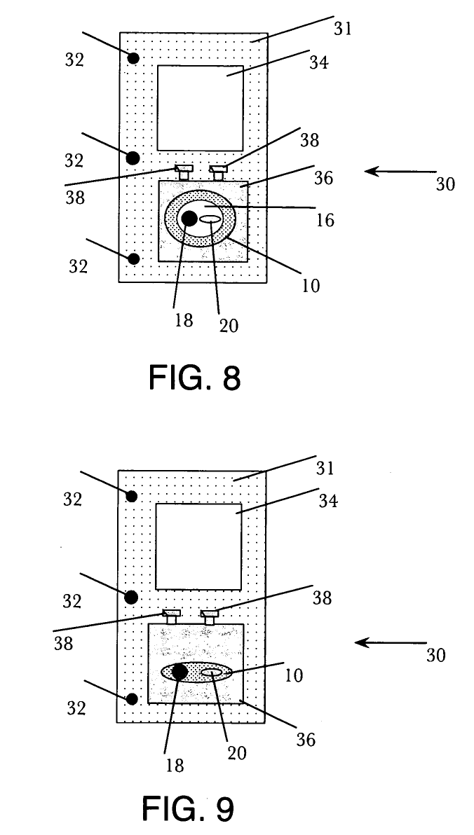

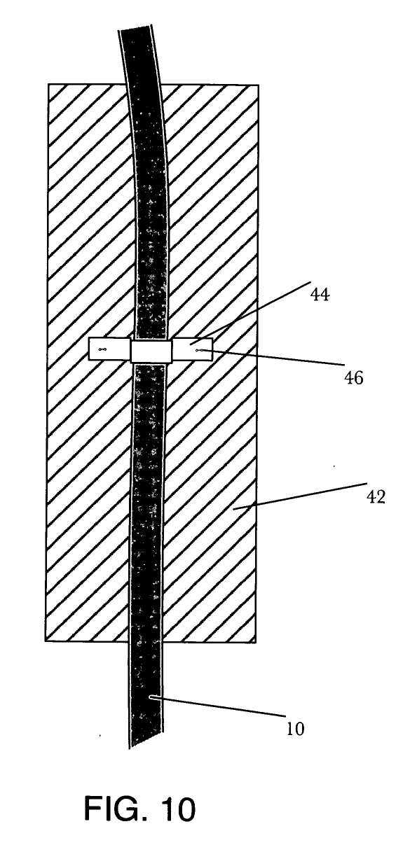

In FIG. 8, the tubing 10 is shown uncompressed with the hollow interior 16 visible. In FIG. 9, the tube clamp 36 is shown in its compressed state, collapsing and thereby eliminating from view the hollow interior 16 shown in FIG. 9, sealing the tubing 10 from heated or cooled air loss.

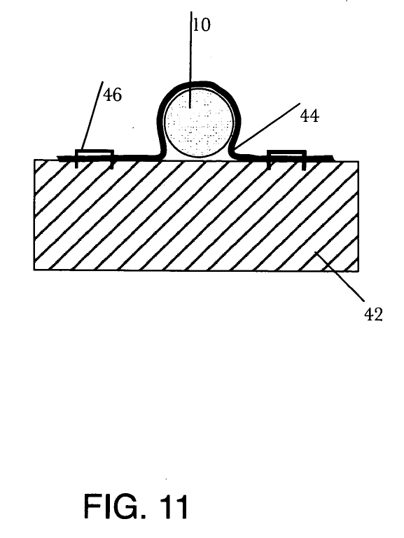

In FIGS. 10 and 11, the tubing 10 is shown secured to an interior support structure when traveling through open sections of a structure. The tubing 10 is secured to an interior support structure 42 by fastener 44, which may be any material capable of securing the tubing 10, such as plastic bands or metal bracket, to the interior support structure 42. In FIGS. 10 and 11 the fastener 44 is secured to the structural supports using staples 46, but other fastening methods, such as nails, adhesives, screws or simply knotting the fastener may be used.

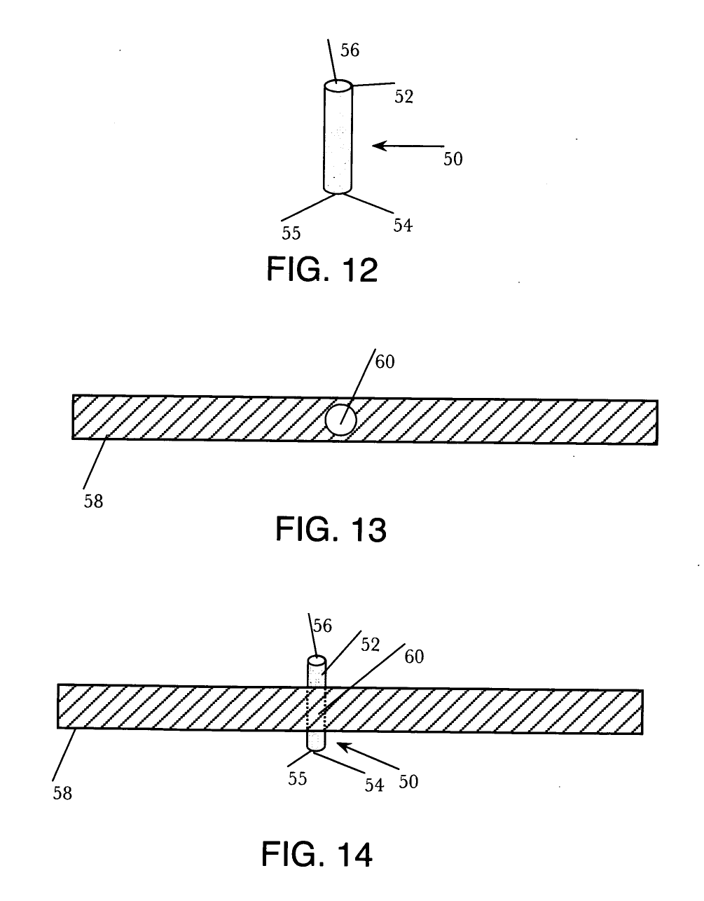

In FIG. 12, a sleeve 50, cylindrical in shape and hollow with a first end 52 and a second end 54 is shown. The sleeve 50 is made of a rigid material, such as metal, plastic or the like and is capable of withstanding the blows from a tool such as a rubber mallet without distorting or breaking while being driven into a hole. Disposed within the first end 52 is an opening 56. Disposed within the second end 54 is an opening 55.

In FIG. 13, a wood plate 58, as found in attics or crawlspaces in structures, is shown. Disposed within the plate 58 is structural penetration hole 60, which can be drilled into the plate 58 during the rough-in phase of construction of the structure.

In FIG. 14, the sleeve 50, used in the preferred embodiment, is shown disposed within the structural penetration hole 60 of the plate 58. The structural penetration hole 60 is sized and shaped to receive the sleeve 50 so that it may be inserted into the hole with a minimum of force, preferably by using a tool such as a rubber mallet.

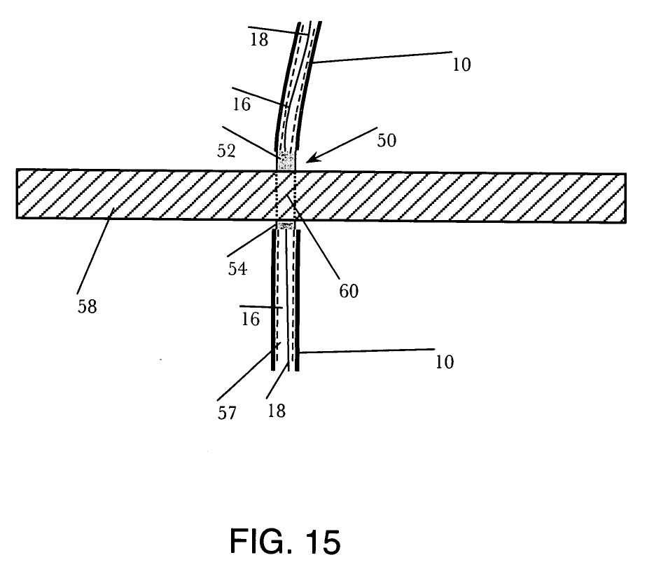

In FIG. 15, the sleeve 50 is shown disposed within the structural penetration hole 60 of the plate 58. The tubing 10 is stretched over the first end 52 of sleeve 50. Another section of tubing 10 is stretched over the second end 54 of sleeve 50 to create a continuous hollow passageway 57, allowing the wire 18 to pass through the plate 58.

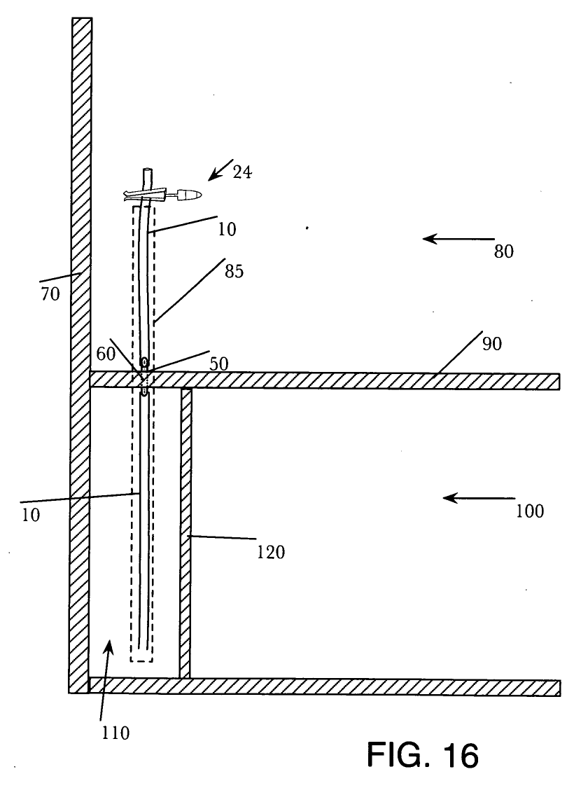

In FIG. 16, a first embodiment of the tube securing member 24 is shown in use. During the rough-in phase of the construction of a structure, prior to the installation of the drywall, the tube securing member 24 is disposed with an attic 80 of a structure. On the label 23, written in is the termination point in the structure of the tubing 10. In FIG. 16, the termination point of tubing 10 is a room 100, which is a room directly below the attic 80 in a one story structure. The tubing 10 is inserted into the opening 22. The tubing 10 communicates with the sleeve 50 that is disposed within the structural penetration hole 60 in an attic plate 90 between the attic 80 and the room 100. In the attic 80, the tubing 10 is stretched over the first end 52 (not shown) of the sleeve 50. In a wall cavity 110 adjacent to the room 100, tubing 10 is stretched over the second end 54 (not shown) of the sleeve 50, which extends into the wall cavity 110 to the desired termination point.

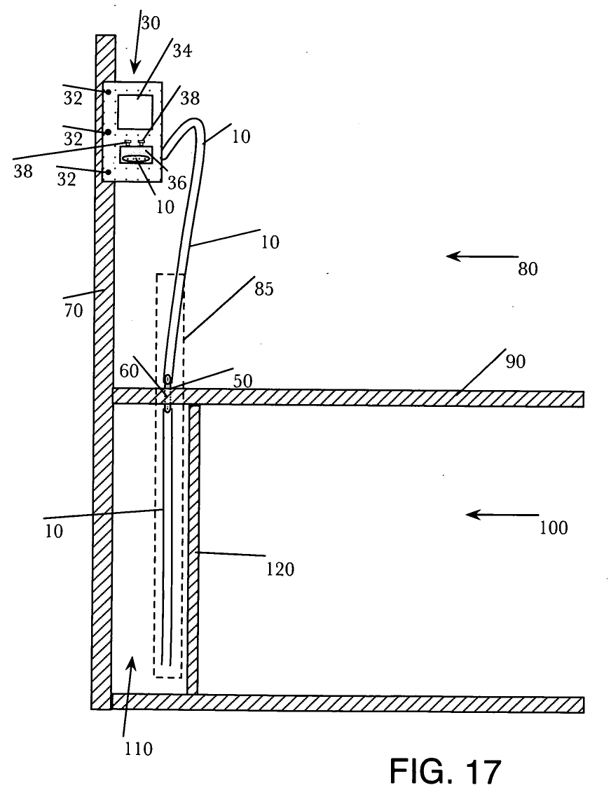

In FIG. 17, the second embodiment utilizing the tube securing member 30 is shown in use. During the rough-in phase of the construction of a structure, prior to the installation of the drywall, the tube securing member 30 is secured to a gable stud 70 in an attic 80 of a structure using the mounting holes 32 through which nails, screws, or staples are disposed, but may also be secured by using any other suitable mounting method. On the labeling surface 34, written in or labeled is the termination point in the structure of the tubing 10. In FIG. 17, the termination point of tubing 10 is a room 100, which is a room directly below the attic 80 in a one story structure. The tubing 10 is inserted into the tube clamp 36. The tubing 10 communicates with the sleeve 50 that is disposed within the structural penetration hole 60 in an attic plate 90 between the attic 80 and the room 100. In the attic 80, the tubing 10 is stretched over the first end 52 (not shown) of the sleeve 50. In a wall cavity 110 adjacent to the room 100, tubing 10 is stretched over the second end 54 (not shown) of the sleeve 50, which extends into the wall cavity 110 to the desired termination point.

While FIG. 17 shows the tubing 10 in the attic 80 combining with the sleeve 50 and the tubing 10 in wall cavity 110 to form a tube assembly 85, in an alterative embodiment, the tubing 10 could be a continuous single tube that travels from the attic 80 to the wall cavity 110, with the tubing 10 compressed and disposed through the structural penetration hole 60.

Wires, cables, fibers or the like are inserted into the tubing 10 when the tube clamp 36 is not compressing the tubing 10. The wires, cables, fibers or the like are pushed through the hollow passageway 57 (shown in FIG. 15) created by tubing 10 and sleeve 50 until it reaches the end of hollow passageway 57. The tube clamp 36 is then tightened to compress the tubing 10, eliminating airflow through the tubing 10 at tube securing member 30.

After the drywall and interior walls have been installed, the tubing 10 can be accessed through a wall 120 between the wall cavity 110 and the room 100 for allowing the wires, cables, fibers or the like disposed within the tubing 10 to be utilized in the room 100.

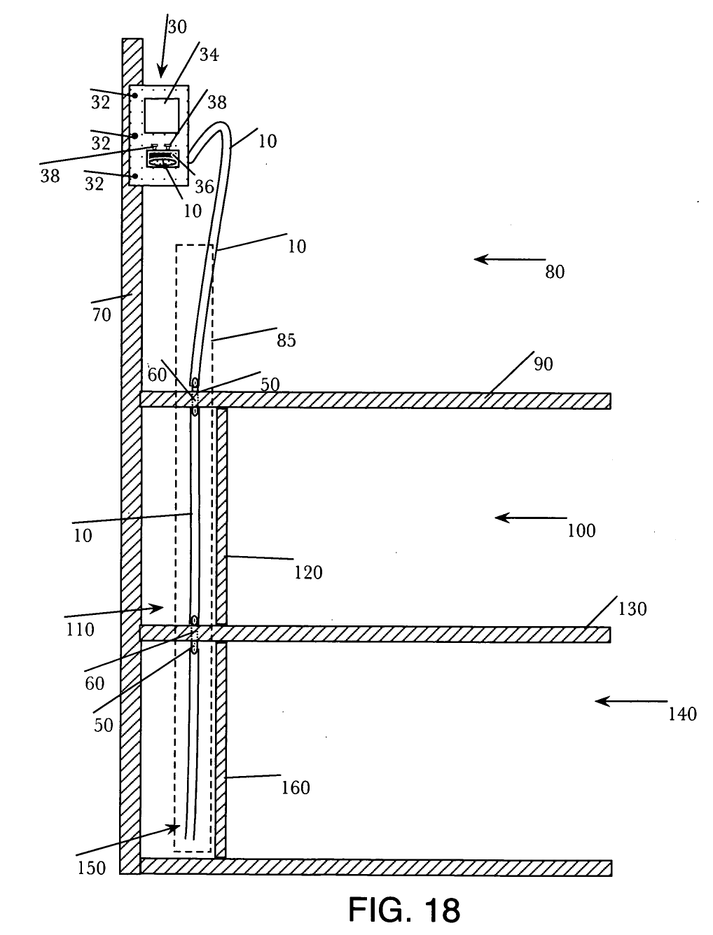

In FIG. 18, an alternative embodiment is shown in a two story structure. During the rough-in phase of the construction of a structure, prior to the installation of the drywall, the tube securing member 30 is secured to a gable stud 70 in an attic 80 of a structure using the mounting holes 32 through which nails, screws, or staples are disposed, but may also be secured by using any other suitable mounting method. On the labeling surface 34, written in or labeled is the termination point in the structure of the tubing 10. In FIG. 18 the termination point of tubing 10 is a room 140, which is a room on the first story of a two story structure. The tubing 10 is inserted into the tube clamp 36. The tubing 10 communicates with the sleeve 50 that is deposed within the structural penetration hole 60 in an attic plate 90 between the attic 80 and the room 100. In the attic 80, the tubing 10 is stretched over the first end 52 (not shown) of the sleeve 50. In a wall cavity 110 adjacent to the room 100, tubing 10 is stretched over the second end 54 (not shown) of the sleeve 50, which extends into the wall cavity to the desired termination point.

While FIG. 18 shows the tubing 10 in the attic 80 combining with the sleeve 50 and the tubing 10 in wall cavity 110, and the sleeve 50 and the tubing in wall cavity 150 to form a tube assembly 85, in an alterative embodiment, the tubing 10 could be a continuous single tube that travels from the attic 80 to the wall cavity 110, with the tubing 10 compressed and disposed through the structural penetration holes 60.

The tubing 10 in wall cavity 110 further communicates with the sleeve 50 that has been disposed within the structural penetration hole 60 in the subfloor 130 between the room 100 and a first story room 140 in a wall cavity 150. In the wall cavity 110, the tubing 10 is stretched over the first end 52 (not shown) of the sleeve 50. In the wall cavity 150 adjacent to the room 140, tubing 10 is stretched over the second end 54 (not shown) of the sleeve 50, which extends into the wall cavity 150.

Wires, cables, fibers or the like may be inserted into the tubing 10 when the tube clamp 36 is not compressing the tubing 10. The wires, cables, fibers or the like are pushed through the hollow passageway 57 (shown in FIG. 15) created by tubing 10 and sleeve 50 until it reaches the end of hollow passageway 57. The tube clamp 36 is then tightened to compress the tubing 10, eliminating airflow through the tubing 10 at tube securing member 30.

After the drywall and interior walls have been installed, the tubing 10 can be accessed through a wall 160 between the wall cavity 150 and the room 140 for allowing the wires, cables, fibers or the like disposed within the tubing 10 to be utilized in the room 140.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. Although the present invention has been described in terms of the foregoing preferred embodiments, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

I claim:

1. An apparatus for allowing the future installation of wires, cables, fibers, and the like within a structure, comprising:
a tube securing member in a first area of a structure; and
a tubing assembly including a first end and second end, wherein the first end of the tubing assembly is secured to the tube securing member in the first area of the structure and the second end of the tubing assembly terminates in a second area of a structure.

2. The apparatus for allowing the future installation of wires, cables, fibers, and the like within a structure according to claim 1, wherein the tubing assembly provides a pathway for wires, cables, fibers and the like to be run from the first area of the structure to the second area of the structure.

3. The apparatus for allowing the future installation of wires, cables, fibers, and the like within a structure according to claim 1, wherein the tubing assembly, comprises:
a sleeve adapted to fit in an opening between the first area of the structure and the second area of the structure thereby providing a channel therebetween; and
at least one section of tubing including a first end and second end, wherein the first end of the tubing is secured to the tube securing member and the second end of the tubing is secured to an end of the sleeve disposed in the first area of the structure.

4. The apparatus for allowing the future installation of wires, cables, fibers, and the like within a structure according to claim 2, wherein the tubing assembly further comprises a second section of tubing secured to an end of the sleeve disposed in the second area of the structure.

5. The apparatus for allowing the future installation of wires, cables, fibers, and the like within a structure according to claim 2, wherein the tubing is hollow and comprised of a compressible material.

6. The apparatus for allowing the future installation of wires, cables, fibers, and the like within a structure according to claim 5, wherein the compressible material is comprised of a compressible foam that, when compressed, prevents airflow through the tubing.

7. The apparatus for allowing the future installation of wires, cables, fibers, and the like within a structure according to claim 5, wherein the compressible material contains insulative properties for preventing convective transfer of heat or cooled air.

8. The apparatus for allowing the future installation of wires, cables, fibers, and the like within a structure according to claim 1, wherein the tube securing member is adapted to compress the tubing assembly such that air cannot flow through the tubing assembly.

9. The apparatus for allowing the future installation of wires, cables, fibers, and the like within a structure according to claim 1, wherein the tube securing member comprises means for attaching the tube securing member to the structure.

10. The apparatus for allowing the future installation of wires, cables, fibers, and the like within a structure according to claim 9, wherein the means for attaching the tube securing member to the structure are holes disposed within the tube securing member for receipt of a fastener therein.

11. The apparatus for allowing the future installation of wires, cables, fibers, and the like within a structure according to claim 10, wherein the fasteners are nails, screws, staples or the like.

12. The apparatus for allowing the future installation of wires, cables, fibers, and the like within a structure according to claim 1, wherein the tube securing member comprises a labeling surface where information may be recorded.

13. The apparatus for allowing the future installation of wires, cables, fibers, and the like within a structure according to claim 12, wherein the information recorded is the termination point of the tubing assembly within the structure.

14. The apparatus for allowing the future installation of wires, cables, fibers, and the like within a structure according to claim 12, wherein the information recorded may be by writing directly onto the labeling surface or by affixing a label onto the labeling section.

15. The apparatus for allowing the future installation of wires, cables, fibers, and the like within a structure according to claim 1, wherein the tube securing member comprises a tubing compression member adapted to apply a compressive force to the tubing assembly thereby sealing the tubing assembly and preventing airflow therethrough.

16. The apparatus for allowing the future installation of wires, cables, fibers, and the like within a structure according to claim 15, wherein the tubing compression member comprises a slot, releasable clamp, a snap, or pressure applying screws.

17. The apparatus for allowing the future installation of wires, cables, fibers, and the like within a structure according to claim 2, wherein the pathway of the tubing assembly is directed through areas of the structure by using a securing means to secure the tubing assembly to structural supports.

18. The apparatus for allowing the future installation of wires, cables, fibers, and the like within a structure according to claim 17, wherein the securing means is a band, strap, bracket or the like that communicates with the tubing assembly and attaches to the structural support using nails, screws, staples or the like.

19. A method of installing a tubing assembly that allows for the future installation of wires, cables, fibers, and the like within a structure, comprising:
constructing a portion of a structure;
securing a tubing assembly to the structure within a first area thereof;
extending the tubing assembly into a second area of the structure; and
completing the construction of the structure.

20. The method of installing a tubing assembly that allows for the future installation of wires, cables, fibers, and the like within a structure according to claim 19 further comprising sealing the tubing assembly to prevent air flow.

21. The method of installing a tubing assembly that allows for the future installation of wires, cables, fibers, and the like within a structure according to claim 19, wherein securing a tubing assembly to the structure within a first area thereof, comprises:
securing a tubing securing member to the structure within a first area thereof; and
attaching the tubing assembly to the securing member.

22. The method of installing a tubing assembly that allows for the future installation of wires, cables, fibers, and the like within a structure according to claim 19, wherein extending the tubing assembly into a second area of the structure, comprises:
creating an opening in the structure between the first area and second area thereof; and
running the tubing assembly from the first area into the second area via the opening.

23. The method-of installing a tubing assembly that allows for the future installation of wires, cables, fibers, and the like within a structure according to claim 19, wherein extending the tubing assembly into a second area of the structure, comprises:
creating an opening in the structure between the first area and second area thereof;
inserting a sleeve into the opening; and
securing a first tubing section of the tubing assembly to the sleeve at the end thereof disposed within the first area of the structure.

24. The method of installing a tubing assembly that allows for the future installation of wires, cables, fibers, and the like within a structure according to claim 23, wherein extending the tubing assembly into a second area of the structure, further comprises securing a second tubing section of the tubing assembly to the sleeve at the end thereof disposed within the second area of the structure.

25. The method of installing a tubing assembly that allows for the future installation of wires, cables, fibers, and the like within a structure according to claim 20, further comprising:
unsealing the tubing assembly; and
inserting wires, cables, fibers or the like into the tubing assembly.
